(19) United States
(12) Patent Application Publication
(10) Pub. No.: US 2006/0156602 A1
(43) Pub. Date: Jul. 20, 2006

(54) Reconfigurable overhead aisle sign

(76) Inventor: Ruth Sheridan Keefe, Cincinnati, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/036,470

(22) Filed: Jan. 14, 2005

(51) Int. Cl. G09F 7/00

(52) U.S. Cl. 40/620

(57) ABSTRACT

The present invention comprises reconfigurable aisle sign comprising a viewable face that includes a linguistic descriptor of a product available within or near a shopping aisle and a pictorial representation of a product available within or near the shopping aisle, where the viewable face is reconfigurable to modify at least one of the linguistic descriptor and the pictorial representation. The present invention also includes a method of selling advertising space that includes providing an aisle sign adapted to be displayed in a retail establishment, where the aisle sign includes reconfigurable elements adapted to provide information on products available within the retail establishment, and selling or leasing advertising space associated with the aisle sign, where the advertising space includes a first name-brand product advertisement utilizing at least one of a pictorial representation and a linguistic description specific to a first name-brand product.

### BACKGROUND

1. Field of the Invention

The present invention is directed to information displays and, more specifically, to reconfigurable aisle signs.

2. Background of the Invention

Aisle signs for stores are well known in the art. Generally, aisle signs provide a summary listing of the types of goods found within a section or aisle of the store. Examples of such signs include grocery store aisle signs that generally include an aisle number and a textual representation of one or more categories of products found within a particular aisle. An exemplary aisle sign may include broad categories such as “backing items,” or be more narrowly tailored to include “cake mixes” and “brownie mixes”.

### SUMMARY

The present invention is directed to reconfigurable signs and, more specifically, to reconfigurable overhead aisle signs displaying product categories and exemplary name brand products falling into one or more of the displayed product categories. In this manner, consumers may be more easily drawn to a particular aisle having the name brand product of choice.

It is a first aspect of the present invention to provide a reconfigurable aisle sign comprising: (a) a viewable face including: (i) a linguistic descriptor of a product available within or near a shopping aisle, and (ii) a pictorial representation of a product available within or near the shopping aisle, where the viewable face is reconfigurable to modify at least one of the linguistic descriptor and the pictorial representation.

In a more detailed embodiment of the first aspect, the viewable face includes a plurality of linguistic descriptors of products available within or near the shopping aisle, and the viewable face includes a plurality of pictorial representations of products available within or near the shopping aisle, and the viewable face is reconfigurable to modify at least one of the plurality of linguistic descriptors and at least one of the plurality of pictorial representations. In yet another more detailed embodiment, the plurality of linguistic descriptors include at least one of broad product classifications, specific product classifications, and name-brand products, and where the plurality of pictorial representations include at least one of broad product representations, specific product representations, and name-brand product representations. In a further detailed embodiment, at least two of the plurality of linguistic descriptors describe at least two name-brand products, and each of the linguistic descriptors describing a name-brand product is associated with a panel adapted to be mounted to the viewable face, where the panel is adapted to be sold or leased by a retailer as an advertisement.

In yet another more detailed embodiment of the first aspect, at least two of the plurality of pictorial representations describe at least two name-brand products, and each of the pictorial representations describing a name-brand product are associated with a panel adapted to be mounted to the viewable face, where the panel is adapted to be sold or leased by a retailer as an advertisement. In still another more detailed embodiment, the linguistic descriptor describes a name-brand product, and the linguistic descriptor is associated with a panel, where the panel is adapted to be sold or leased by a retailer as an advertisement. In a further detailed embodiment, the pictorial representation is of a name-brand product, and the pictorial representation is associated with a panel, where the panel is adapted to be sold or leased by a retailer as an advertisement.

It is a second aspect of the present invention to provide a reconfigurable aisle sign comprising: (a) a viewable face including: (i) a first section comprising a plurality of linguistic descriptors of products available within or near a shopping aisle, where the plurality of linguistic descriptors includes at least one of broad product classifications, specific product classifications, and name-brand products, and where at least one of the plurality of linguistic descriptors of products is positioned on a panel temporarily mounted to the viewable face, (ii) a second section comprising a plurality of pictorial representations of products available within or near the shopping aisle, where the plurality of pictorial representations includes at least one of broad product representations, specific product representations, and name-brand product representations, and where at least one of the plurality of pictorial representations of products is positioned on a panel temporarily mounted to the viewable face, and (iii) a third section comprising a variable entry field that includes at least one of pictorial information and linguistic information concerning at least one of public service announcements and product advertising, where the advertising information includes references to name-brand products, where the viewable face is reconfigurable to change at least one of the plurality of linguistic descriptors, at least one of the plurality of pictorial representations, and at least some of the information comprising the variable entry field.

In yet another more detailed embodiment of the second aspect, at least one of the first section and the second section includes a name-brand product reference. In still another more detailed embodiment, at least one of the first section, the second section, and the third section includes advertising space referencing a name-brand product, where the advertising space is adapted to be sold or leased by a retailer. In a further detailed embodiment, the first section includes the advertising space and the advertising space is adapted to be occupied by at least one of the plurality of pictorial representations. In still a further detailed embodiment, the third section includes the advertising space and the advertising space is adapted to be occupied by at least one of the pictorial information and the linguistic information.

It is a third aspect of the present invention to provide a method of disseminating consumer information comprising: (a) positioning an aisle sign in proximity to a consumer shopping aisle, the aisle sign including linguistic product information relevant to types of products found within or near the consumer shopping aisle and graphical product information relevant to types of products found within or near the consumer shopping aisle, where at least one of the linguistic product information and the graphical product information includes a name-brand product; and (b) reconfiguring at least one of the linguistic product information and the graphical product information by repositioning panels of the aisle sign that include the linguistic product information and the graphical product information.

It is a fourth aspect of the present invention to provide a method of selling advertising space comprising: (a) providing an aisle sign adapted to be displayed in a retail establishment, where the aisle sign includes reconfigurable elements adapted to provide information on products available within the retail establishment; and (b) selling or leasing advertising space associated with the aisle sign, where the advertising space includes a first-name-brand product advertisement utilizing at least one of a pictorial representation and a linguistic description specific to a first name-brand product.

In yet another more detailed embodiment of the fourth aspect, the aisle sign includes categories of products available within an aisle of the retail establishment, and the first name-brand product fits into at least one of the categories listed on the aisle sign. In still another more detailed embodiment, the method further comprises reconfiguring the advertising space to replace the first name-brand product advertisement with a second name-brand product advertisement that is sold or leased, where the second name-brand product advertisement includes at least one of a pictorial representation and a linguistic description specific to a second name-brand product. In a further detailed embodiment, In still a further detailed embodiment, the act of selling or leasing advertising space includes displaying a first public service advertisement, and the act of reconfiguring the advertising space includes replacing the first public service advertisement with a second public service advertisement.

### BRIEF DESCRIPTION OF THE DRAWINGS

FIG. 1 is a first exemplary embodiment of the present invention;

FIG. 2 is a first alternate exemplary embodiment of the present invention;

FIG. 3 is a second exemplary embodiment of the present invention; and

FIG. 4 is a third exemplary embodiment of the present invention.

### DETAILED DESCRIPTION

The exemplary embodiments of the present invention are described and illustrated below to encompass aisle signs for use in a retail establishment. Of course, it will be apparent to those of ordinary skill in the art that the preferred embodiments discussed below are exemplary in nature and may be reconfigured without departing from the scope and spirit of the present invention. However, for clarity and precision, the exemplary embodiments as discussed below may include optional features that one of ordinary skill should recognize as not being a requisite to fall within the scope of the present invention.

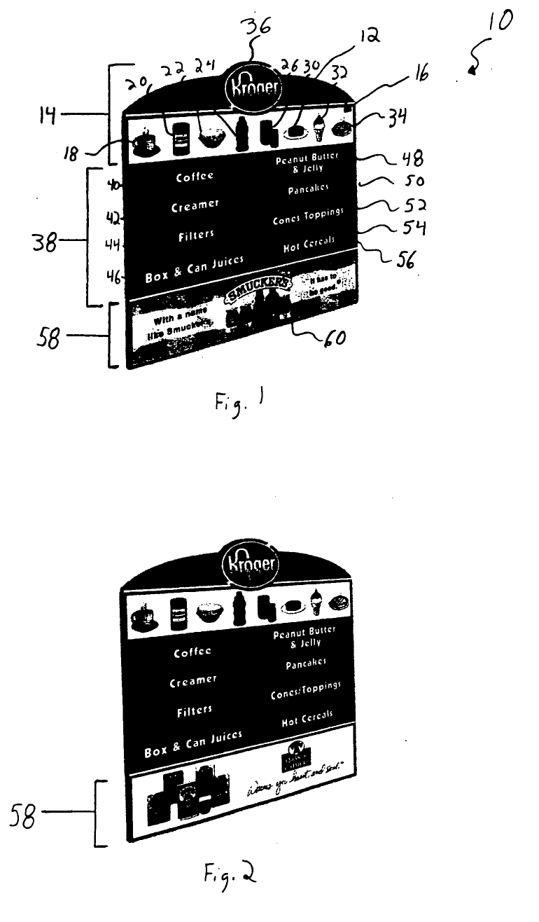

Referencing FIG. 1, a first exemplary embodiment of the present invention includes an overhead aisle sign 10 adapted to be mounted in an elevated manner to enable consumers to view one or more relevant portions of the sign 10 from various points within a retail establishment. The overhead sign 10 may be two-dimensional (flat) or may be fabricated in a three-dimensional arrangement. An exemplary three-dimensional arrangement includes a cubic shape providing multiple viewing faces 12 viewable respectively from the front, rear, right side, and left side. For purposes of explanation, at least two of the sides would be viewable by a consumer within the particular aisle over which the sign 10 is mounted.

An exemplary viewable face 12 of the overhead aisle sign 10 includes a header 14 having pictorial or graphical representations 16 of items consumers may find located within the aisle over which the sign 10 hangs. In this exemplary embodiment, the pictorial representations may be generic, such as a picture of a coffee cup 18, or may be brand specific such as a Maxwell House® coffee cup (not shown). In either instance, the pictorial representation conveys to consumers that coffee and coffee related products are found within the aisle over which the sign 10 hangs. Other exemplary pictorial representations may be added to represent particular products or types of products located within an aisle, such as, without limitation, a picture of a coffee creamer container 20, a picture of a coffee filter 22, a picture of a grape juice container 24, a picture of a peanut butter container and a jelly container 26, a picture of a stack of pancakes 30, a picture of an ice cream cone 32, and a picture of a bowl of soup 34. Those of ordinary skill are familiar with the various pictorial representations of brand name products, as well as pictorial representations of generic products or product groups that may be substituted for, or used in lieu of, the exemplary pictorial representations discussed above. In addition, the header 14 may also include aisle numbering and store specific indicia 36.

The header 14 may be comprised of one or more reconfigurable panels 18 that may be secured to the sign 10 using magnets, adhesive, hook and pile fasteners, or other fasteners. In this manner, the header 14 can be modified to change the positioning of one or more of the pictorial representations 16. For example, one or more of the pictorial representations 16 may comprise laminated cut-outs of products such as the coffee creamer container 20, the coffee filter 22, and the grape juice container 24, where the representations 16 include a magnetic backing. The magnetic backing would be adapted to adhere to the sign 10 and enable the representations 16 to be oriented in various manners, such as those shown in FIG. 1. Thereafter, store management might decide to change the order of the representations 16, as well as replace some of the representations 16 with other representations 16. In this manner, management of the retail establishment is provided great flexibility as to what is graphically displayed on the sign 10.

An exemplary linguistic or text-based descriptor section 38 is also provided on the sign 10. This descriptor section 38 may include brand name references or may exclusively recite generic product categories. An exemplary linguistic representation to be included in this section 38 might include a brand specific reference to Coca-Cola®, or may simply list the generic category of “Soft Drinks.” Other exemplary linguistic representations may be added to describe products or types of products located within or near the aisle, such as, without limitation, the text “Coffee” 40, the text “Creamer” 42, the text “Filters” 44, the text “Box & Can Juices” 46, the text “Peanut Butter & Jelly” 48, the text “Pancakes” 50, the text “Cones/Toppings” 52, and the text “Hot Cereals” 54. In general, this section is intended to capture the attention of individuals that are looking for linguistic references to identify products or types of products of interest.

The descriptor section 38 may be comprised of multiple reconfigurable panels 56 that may be secured to the sign 10 using magnets, adhesive, hook and pile fasteners, or other fasteners. In this manner, the descriptor section 38 can be modified to change the positioning of one or more of the linguistic representations. For example, one or more of the linguistic representations may comprise laminated cut-outs of text such as the text “Coffee” 40 or “Creamer” 42 or “Filters” 44, where the representations include a magnetic backing. The magnetic backing would be adapted to adhere to the sign 10 and enable the linguistic representations to be oriented in various manners, such as those shown in FIG. 1. Thereafter, management of the retail establishment might decide to change the order of the linguistic representations, as well as replace some of the linguistic representations with other linguistic representations. For example, the text “Coffee” 40 might be replaced with the text “Tea.” In this manner, the store management is provided great flexibility as to what is linguistically displayed on the sign 10.

The sign 10 may also include a variable information section 58 for providing additional consumer information. This variable information section 58 may include brand name references or may exclusively recite generic product categories. For example, referring to FIG. 1, the variable information section 58 includes a banner advertisement for Smucker's® products 60. FIG. 2 shows an alternate exemplary embodiment including banner advertisement for Quaker® Oatmeal products occupying the variable information section 58. In each example, the banner advertisement is large enough to provide both pictures of the products, as well as linguistic materials, such as a product slogan and trademark. More specifically, the variable information section 58 is intended to provide higher profile advertisement information than would otherwise be provided by solely using the above-referenced graphical and linguistic representations in the header 14 and descriptor section 38.

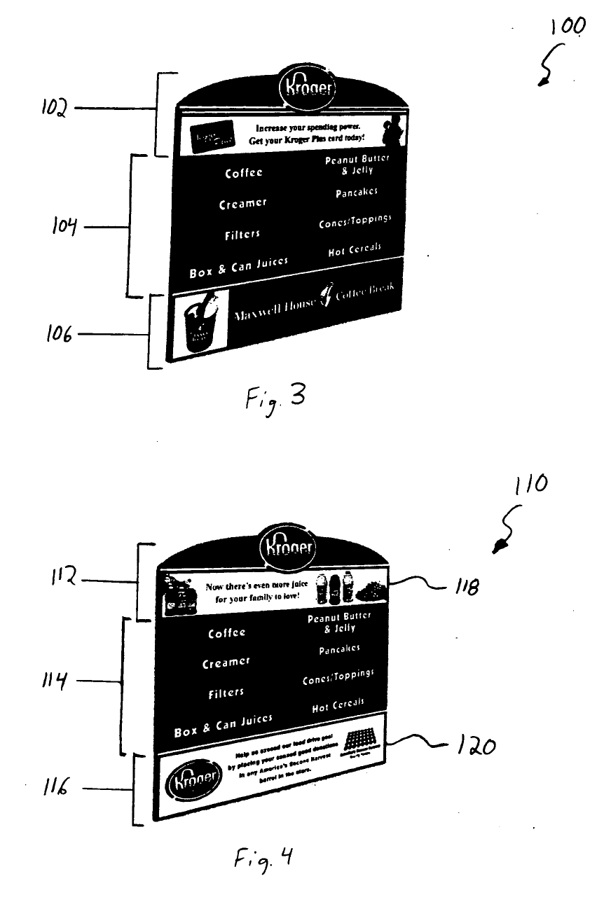

Referring to FIG. 3, a second exemplary sign 100 in accordance with the present invention includes three information sections 102, 104, 106. The first information section is in the form of a banner advertisement enticing consumers to use a store-specific shopping card to save money. One or more banner advertisements, product listings, product pictures, or other information consumers might find informative while shopping may occupy this first information section 102. The second information section 104 includes linguistic product listings in an analogous fashion to the descriptor section 38 (See FIG. 1) of the first exemplary embodiment. Finally, the third information section 106 provides specific product advertising information.

As with the first exemplary embodiment 10, the second exemplary sign 100 may comprise multiple reconfigurable panels that may be secured to the sign 100 using magnets, adhesive, hook and pile fasteners, or other fasteners. In this manner, the panels can be repositioned or switched out to provide particular information.

It is to be understood that this second exemplary sign 100 need not include information that is specific to an item found within or near an aisle of a retail establishment. For instance, the sign 100 may include a reference to consumers using a Visa® check card or other product/service. Still further, one of the sections 102, 104, 106 may be omitted to provide additional space for one of the remaining sections 102, 104, 106.

Referencing FIG. 4, a third exemplary sign 110 of the present invention also includes three sections 112, 114, 116. The first section 112 includes a banner advertisement 118 for a specific product, Welch's® juices. While the majority of this first section 112 is occupied by the banner advertisement 118, it is within the scope of the invention to provide multiple advertisements specific to brand name products. The second section 114 provides a linguistic product listing in an analogous fashion to the descriptor section 38 (See FIG. 1) of the first exemplary embodiment. Finally, the third information section 116 provides public service information 120. Public service information includes any information about which the public-at-large would be commonly interested in knowing. Exemplary public service information includes dates during which the retailer is colleting used coats or collecting canned food items for a local food pantry.

As with the first exemplary embodiment 10, the third exemplary sign 110 may comprise multiple reconfigurable panels that may be secured to the sign 110 using magnets, adhesive, hook and pile fasteners, or other fasteners. In this manner, the panels can be repositioned or switched out to provide particular information.

It is to be understood that the shape and layout of the exemplary embodiments discussed above are completely for illustrative purposes and do not constitute a necessary feature of the present invention.

It is within the scope and spirit of the present invention that the signs 10, 100, 110 be illuminated. Those of ordinary skill will understand that exemplary illumination includes back lighting and frontal lighting, where the frontal lighting may be the preexisting lighting present within the retail establishment.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A reconfigurable aisle sign comprising:
a viewable face including:
a linguistic descriptor of a product available within or near a shopping aisle; and
a pictorial representation of a product available within or near the shopping aisle;
where the viewable face is reconfigurable to modify at least one of the linguistic descriptor and the pictorial representation.

2. The reconfigurable aisle sign of claim 1, wherein:
the viewable face includes a plurality of linguistic descriptors of products available within or near the shopping aisle; and
the viewable face includes a plurality of pictorial representations of products available within or near the shopping aisle;
where the viewable face is reconfigurable to modify at least one of the plurality of linguistic descriptors and at least one of the plurality of pictorial representations.

3. The reconfigurable aisle sign of claim 2, wherein:
the plurality of linguistic descriptors include at least one of broad product classifications, specific product classifications, and name-brand products; and
the plurality of pictorial representations include at least one of broad product representations, specific product representations, and name-brand product representations.

4. The reconfigurable aisle sign of claim 2, wherein:
at least two of the plurality of linguistic descriptors describe at least two name-brand products; and
each of the linguistic descriptors describing a name-brand product is associated with a panel adapted to be mounted to the viewable face, where the panel is adapted to be sold or leased by a retailer as an advertisement.

5. The reconfigurable aisle sign of claim 2, wherein:
at least two of the plurality of pictorial representations describe at least two name-brand products; and
each of the pictorial representations describing a name-brand product are associated with a panel adapted to be mounted to the viewable face, where the panel is adapted to be sold or leased by a retailer as an advertisement.

6. The reconfigurable aisle sign of claim 1, wherein:
the linguistic descriptor describes a name-brand product; and
the linguistic descriptor is associated with a panel, where the panel is adapted to be sold or leased by a retailer as an advertisement.

7. The reconfigurable aisle sign of claim 1, wherein:
the pictorial representation is of a name-brand product; and
the pictorial representation is associated with a panel, where the panel is adapted to be sold or leased by a retailer as an advertisement.

8. A reconfigurable aisle sign comprising:
a viewable face including:
a first section comprising a plurality of linguistic descriptors of products available within or near a shopping aisle, where the plurality of linguistic descriptors includes at least one of broad product classifications, specific product classifications, and name-brand products, and where at least one of the plurality of linguistic descriptors of products is positioned on a panel temporarily mounted to the viewable face;
a second section comprising a plurality of pictorial representations of products available within or near the shopping aisle, where the plurality of pictorial representations includes at least one of broad product representations, specific product representations, and name-brand product representations, and where at least one of the plurality of pictorial representations of products is positioned on a panel temporarily mounted to the viewable face; and
a third section comprising a variable entry field that includes at least one of pictorial information and linguistic information concerning at least one of public service announcements and product advertising, where the advertising information includes references to name-brand products;
where the viewable face is reconfigurable to change at least one of the plurality of linguistic descriptors, at least one of the plurality of pictorial representations, and at least some of the information comprising the variable entry field.

9. The reconfigurable aisle sign of claim 8, wherein:
at least one of the first section and the second section includes a name-brand product reference.

10. The reconfigurable aisle sign of claim 8, wherein:
at least one of the first section, the second section, and the third section includes advertising space referencing a name-brand product, where the advertising space is adapted to be sold or leased by a retailer.

11. The reconfigurable aisle sign of claim 10, wherein:
the first section includes the advertising space and the advertising space is adapted to be occupied by at least one of the plurality of pictorial representations.

12. The reconfigurable aisle sign of claim 10, wherein:
the third section includes the advertising space and the advertising space is adapted to be occupied by at least one of the pictorial information and the linguistic information.

13. A method of disseminating consumer information comprising:
positioning an aisle sign in proximity to a consumer shopping aisle, the aisle sign including linguistic product information relevant to types of products found within or near the consumer shopping aisle and graphical product information relevant to types of products found within or near the consumer shopping aisle, where at least one of the linguistic product information and the graphical product information includes a name-brand product; and
reconfiguring at least one of the linguistic product information and the graphical product information by repositioning panels of the aisle sign that include the linguistic product information and the graphical product information.

14. A method of selling advertising space comprising:
providing an aisle sign adapted to be displayed in a retail establishment, where the aisle sign includes reconfigurable elements adapted to provide information on products available within the retail establishment; and
selling or leasing advertising space associated with the aisle sign, where the advertising space includes a first name-brand product advertisement utilizing at least one of a pictorial representation and a linguistic description specific to a first name-brand product.

15. The method of claim 14, wherein:
the aisle sign includes categories of products available within an aisle of the retail establishment; and
the first name-brand product fits into at least one of the categories listed on the aisle sign.

16. The method of claim 14, further comprising:
reconfiguring the advertising space to replace the first name-brand product advertisement with a second name-brand product advertisement that is sold or leased, where the second name-brand product advertisement includes at least one of a pictorial representation and a linguistic description specific to a second name-brand product.

17. The method of claim 16, wherein:
the act of selling or leasing advertising space includes displaying a first public service advertisement; and
the act of reconfiguring the advertising space includes replacing the first public service advertisement with a second public service advertisement.
